(19) United States
(12) Patent Application Publication
(10) Pub. No.: US 2008/0279403 A1
(43) Pub. Date: Nov. 13, 2008

(54) Headset and a Headphone

(76) Inventors: Charles L. Pedersen, Virum (DK); Martin G. Bech, Frederikssund (DK)

Correspondence Address: Altera Law Group, LLC, 220 S 6 St Suite 1700, Minneapolis, MN, 55402, US

(21) Appl. No.: 11/628,023

(22) PCT Filed: May 30, 2005
(86) PCT No.: PCT/DK05/00357

§ 371 Date: Jul. 12, 2007

(30) Foreign Application Priority Data
May 28, 2004 (DK) PA 2004 00841

(51) Int. Cl. H04R 5/02

(52) U.S. Cl. 381/311; 381/309

(57) ABSTRACT

A headset (1) and a headphone has two speakers (2, 3) connected via a headband (4) and is configured such that the headset may be used as a conventional headset or as a stereo speaker set, where the speakers of the headband and the headset constitute supports against a substrate. The headband may expediently be made of a permanently deformable material in the form of a sandwich structure, which is constructed as three layers, or may be composed of one or more rotary joints or of one or more bistable joints, which provides many possible settings of the support against the substrate, of which there may be more than one. In addition, the headset may incorporate a DSP which is adapted to received signals from a sensor sensing whether the headset is used as a conventional headset or as a stereo speaker set, and, where appropriate, sets some ether electrical circuits incorporated in the headset, which regulate volume and transmission characteristics, automatically on the basis of the sensed signals.

The invention relates to a headset which is formed by two speakers interconnected by means of a headband, wherein the speakers are rotatably connected with the headband, and wherein the headband, in addition to being capable of being placed on a user's head, may be placed on a substrate so that the speakers and the headband constitute support points against the substrate.

The invention moreover relates to a headphone which is formed by two speakers interconnected by means of a headband, wherein the speakers are movable relative to the headband, and wherein the headset, in addition to being capable of being placed on a user's head, may be placed on a substrate so that the speakers and the headband constitute support points against the substrate.

GB Patent No. 1,044,819 describes a headset, where the speakers of the headset may be removed from the headset and be inserted into a holder, so that the headset may be used both as a conventional headset and as a stand-alone stereo speaker set. It is rather cumbersome to switch the speakers of the known headset from use as an ordinary headset to use as a stereo speaker set.

A headset of the type defined in the introductory portion of the claims is known from JP 2000316198. This known headset may be used as a conventional headset and as a stereo speaker set, where the speakers of the headset and the headband may be placed on a substrate. When the headset is used as a stereo speaker set, the direction of the speakers may be adjusted by means of rotary joints which are arranged in the transition between the speakers and the headband of the headset.

Now, an object of the invention is to provide a more flexible headset which provides for more possible settings, such as adapting the transmission characteristics to a given use.

The object of the invention is achieved by a headset of the type defined in the introductory portion of the claims, which is characterized in that it is equipped with a DSP, which is adapted to receive signals from a sensor sensing whether the headset is used as a conventional headset or as a stereo speaker set.

For optimum use of the headset as an ordinary headset or as stand-alone speakers, it is expedient if, as stated in the claims, it is provided with circuits for user-specific volume and transmission characteristics, which are adapted to the use of the headset as a conventional headset or as a stereo speaker set.

It may be mentioned by way of example that, as stated in the claims, the transmission characteristics are to be set such that the bass is to be more predominant when the headset is used as a stereo speaker set, and less predominant when it is used as a conventional headset.

To increase the user comfort of the headset additionally, it is advantageous if, as stated in the claims, a microphone is arranged near the one speaker, and, as stated in the claims, that the headset has a switch which is adapted to cut off the microphone when the speakers are positioned in the direction which is perpendicular to the user's ears, and, as stated in the claims, that the headset is of a wireless type. Of the Bluetooth type, e.g., as stated in the claims. Both speech signals and other audio signals, e.g. stereo signals in the form of music, may hereby be received/transmitted wirelessly by the headset.

When, as stated in the claims, the headband is composed of one or more rotary joints, such as ball joints, or, as stated in the claims, the headband is composed of one or more bistable joints, it is easy to manipulate the direction of the sound propagation direction of the speakers.

As stated in the claims, the headset may be a headphone, which may likewise be used as a conventional set of headphones or as a stereo speaker set.

Expedient embodiments for the headphone are defined in the claims.

The invention will now be explained more fully with reference to the drawing, in which

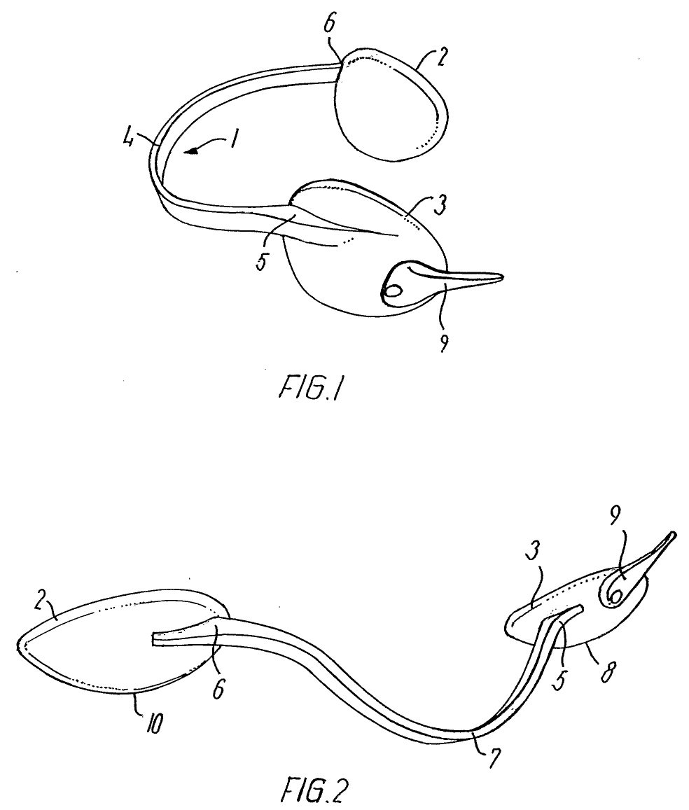

FIG. 1 shows the headset according to the invention in a first position of use as a headset, while

FIG. 2 shows the headset according to the invention in a second position of use as stand-alone speakers.

In FIGS. 1 and 2, a headset according to the invention is designated 1 in its entirety.

As will be seen, the headset has two speakers 2, 3 which are connected with a headband 4 expediently made of a permanently deformable material. This permanently deformable material may be composed as a sandwich structure in the form of a laminate of at least two layers, preferably three layers, which are formed by a plastics layer, a metal layer and a plastics layer, where the plastics layer may be Santoprene or another polyethylene material.

Generally, the laminate may be made by embedding the metal layer in the plastics material. Electrical wires between the speakers of the headset may also be embedded in the laminate.

As indicated, the ends of the headband are secured to the speakers in attachment points 5, 6.

One of the speakers, here the speaker 3, has a microphone 9 so as to enable e.g. wireless communication via a Bluetooth connection to a mobile phone or other communications equipment.

Although not shown, the speakers are mounted in capsules which, in addition to the speakers, may contain suitable electronics and operating buttons, as is already known.

As will be seen in FIG. 1, the sound propagation direction of the speakers points toward each other, corresponding to the headset having been set to be positioned on a user's head, and with a headband configured as a neckband.

In FIG. 2, the speakers are rotated away from each other, which is possible since the headband is made of a permanently deformable material.

In addition, the central part of the headband is bent downwards so that the headset now has three support points, one 7 of which is located at the centre of the headband, the two others 8, 9 being formed by the edge of the speakers or the capsules of the speakers.

It is also possible to provide more than three support points, it being possible to bend the headband downwards at several points which are positioned longitudinally of the headband.

Further, the headband may e.g. be configured as a stirrup or a band which extends over the head, alternatively as a neckband or a stirrup extending under the chin.

As an alternative or as a supplement to the headband being made of a permanently deformable material, it is possible to construct a headband of several joints, which are composed of one or more rotary joints or one or more bistable joints. The rotary joints may moreover be formed as ball joints, which provides for possible settings in three planes.

Finally, a DSP (Digital Signal Processor) may be incorporated in the headset, said DSP receiving signals from a sensor which may be positioned in the transition between one of the capsules of the headset and the headband, said sensor being adapted to sense whether the headset is used as a conventional headset or as stereo speakers. The transition between the capsules of the headset and the headband may e.g. be configured as a joint.

Where appropriate, the DSP may automatically set some electrical circuits, such as volume and transmission characteristics, incorporated in the headset, on the basis of the signals from the sensor, depending on whether the headset is used as a conventional headset or as a stereo speaker set.

As will be appreciated, the invention provides a very flexible headset which may be used in many operative configurations while maintaining a high sound quality, which it is possible to fulfill, especially with modern speaker technology.

1-17. (canceled)

18. A headset (1), which is formed by two speakers (2, 3) interconnected by means of a headband (4), wherein the speakers (2, 3) are movable relative to the headband, and wherein the headset, in addition to being capable of being placed on a user's head, may be placed on a substrate, so that the speakers and the headband constitute support points against the substrate, wherein it is equipped with a DSP, which is adapted to receive signals from a sensor sensing whether the headset is used as a conventional headset or as a stereo speaker set.

19. A headset according to claim 18, wherein it is provided with circuits for user-specific volume and transmission characteristics, which are adapted to the use of the headset as a conventional headset or as stand-alone speakers.

20. A headset according to claim 19, wherein the transmission characteristics are such that the bass is more predominant when the headset is used as a stereo speaker set, and that the bass is less predominant when it is used as a conventional headset.

21. A headset according to claim 18, wherein a microphone (9) is arranged near the one speaker (3).

22. A headset according to claim 18, wherein the headset has a switch which is adapted to cut off the microphone when the speakers are positioned in the direction which is perpendicular to the user's ears.

23. A headset according to claim 18, wherein it is of a wireless type.

24. A headset according to claim 18, wherein it is of the Bluetooth type.

25. A headset according to claim 18, wherein the headband is composed of one or more rotary joints, such as ball joints.

26. A headset according to claim 18, wherein the headband is composed of one or more bistable joints.

27. A headphone (1), which is formed by two speakers (2, 3) interconnected by means of a headband (4), wherein the speakers (2, 3) are movable relative to the headband, and wherein the headphone, in addition to being capable of being placed on a user's head, may be placed on a substrate so that the speakers and the headband constitute support points against the substrate, wherein it is equipped with a DSP, which is adapted to receive signals from a sensor sensing whether the headphone is used as a conventional headphone or as a stereo speaker set.

28. A headphone according to claim 27, wherein it is provided with circuits for user-specific volume and transmission characteristics, which are adapted to the use of the headphone as a conventional headphone or as stand-alone speakers.

29. A headphone according to claim 28, wherein the transmission characteristics are such that the bass is more predominant when the headphone is used as a stereo speaker set, and that the bass is less predominant when it is used as a conventional headphone.

30. A headphone according to claim 27, wherein it is of a wireless type.

31. A headphone according to claim 27, wherein it is of the Bluetooth type.

32. A headphone according to claim 27, wherein the headband is composed of one or more rotary joints, such as ball joints.

33. A headphone according to claim 27, wherein the headband is composed of one or more bistable joints.
